(19) United States
(12) Patent Application Publication
(10) Pub. No.: US 2026/0369891 A1
(43) Pub. Date: Nov. 19, 2026

(54) ANTENNA ELEMENT WITH FILTERING PROPERTIES

(71) Applicant: SAAB AB, Linköping (SE)

(72) Inventors: Matti KUOSMANEN, Helsinki (FI); Juha ALA-LAURINAHO, Espoo (FI); Ville VIIKARI, Espoo (FI); Jari HOLOPAINEN, Vantaa (FI); Tero KIURU, Espoo (FI)

(21) Appl. No.: 19/133,481

(22) PCT Filed: Dec. 4, 2023
(86) PCT No.: PCT/SE2023/051218

§ 371 Date: May 28, 2025

(30) Foreign Application Priority Data
Dec. 13, 2022 (FI) 20226101

(51) Int. Cl. H01Q 13/08

(52) U.S. Cl. CPC H01Q 13/085

(57) ABSTRACT

An antenna element (1) comprising at least a first planar conductive layer (3) is described. A cutout (6) is formed in the first planar conductive layer (3), which cutout (6) defines two opposing parts (7, 7′) of the conductive layer (3), wherein the opposing edges (8, 8′) of the opposing parts (7, 7′) follow a respective main curve (9, 9′) and define a tapering shape from a first end (13), at an edge of the first planar conductive layer (3), to a second end (14). The cutout (6) comprises, in each one of the opposing sides (8, 8′) a plurality of secondary cutouts (15, 15′) extending from the main curves. The antenna element comprises a waveguide (19) surrounding at least a part of the length of the cutout (6). The lengths (L) of the secondary cutouts (15, 15′) from the main curves (9, 9′) vary in the direction of the length axis (10), with the shortest secondary cutouts (15, 15′) closest to the ends of the cutout (6).

### TECHNICAL FIELD

The present invention relates to an antenna element comprising at least a first planar conductive layer wherein a cutout is formed in the first planar conductive layer. Such antennas are known in the art as notch antennas.

### BACKGROUND ART

Notch antennas configured on Printed Circuit Boards, PCBs, are well known in the field of antennas. Notch antennas do not have to be configured on PCBs, but configuration of the notch antennas on PCBs provide various benefits such as facilitated production. In order to increase bandwidth different variants of notch antennas have been developed, such as tapered slot antennas and exponentially tapered slot antennas, also known as Vivaldi antennas. In general, antenna elements are designed to operate on a specific frequency range. On this frequency range, the antenna element has feasible performance, including active reflection coefficients and beam steering capability.

However, many antenna elements, such as Vivaldi elements, do not have inherent limit for the highest operation frequency. In other words, there may be several passbands above the designed highest frequency. This might be a problem for a receiving radio system, if there is a strong interfering signal outside the designed frequency band. The signals outside the operational frequency band may saturate the receiver if the system does not have a good filter. When a plurality of antenna elements are used in an antenna array it is also desirable that the antenna array has a good directivity such that the electromagnetic radiation is transmitted in the correct direction.

Another implementation in which high-performance filters are needed, is the transmission of noisy or distorted signal, or a signal containing spurious emissions. Since realistic transmitters always generate some extra frequencies unintentionally, i.e., spurious signals, and also distort the intended transmission and corrupt it with noise, these unwanted components are also transmitted to air if the transmitting radio system does not include a proper filter. These out-of-band emissions may interfere other systems and radiate to unwanted directions.

Clearly, radio systems should have a good filter both for reception and transmission. Good filters have a steep transition band, low losses, and high attenuation at the stop band. However, these requirements often mean bulky and expensive external filter that might not fit into modern active antenna arrays.

The highest grating-lobe free design frequency of a Vivaldi antenna array is defined by the spacing between centre points of the adjacent elements in a Vivaldi antenna array. However, there are additional pass-bands above the highest design frequency. The low frequency limit for a Vivaldi antenna array is, due to deteriorating impedance matching, defined by the physical size of the antenna element. However, the transition band of this natural high-pass filter is not steep and the antenna array does not work as a proper high-pass filter without modification.

### SUMMARY OF THE INVENTION

An objective of the present invention is to provide an antenna element which at least alleviates one of the problems with the prior art antenna elements.

Another objective of the present invention is to provide an antenna element which has filtering properties such that frequencies outside a desired frequency band are attenuated by the antenna element.

At least one of these objectives is achieved with an antenna element according to the independent claim.

Further advantages are provided with the features of the dependent claims.

According to a first aspect an antenna element is provided comprising at least a first planar conductive layer. A cutout is formed in the first planar conductive layer, which cutout defines two opposing parts of the conductive layer, wherein the opposing edges of the opposing parts follow a respective main curve on respective sides of a straight length axis in the plane of the conductive layer. The main curves define a tapering shape from a first end, at an edge of the first planar conductive layer, to a second end, and the cutout comprises, in each one of the opposing sides a plurality of secondary cutouts extending from the main curves. The antenna element is characterized in that it comprises a waveguide surrounding at least a part of the length of the electromagnetic cutout along the length axis, and in that the length of the secondary cutouts from the main curve varies in the direction of the length axis, with the shortest secondary cutouts closest to the ends of the cutout along the length axis.

The secondary cutouts can be said to form indentations.

The antenna element according to the first aspect is suitable for use in an antenna array,

An antenna element according to the first aspect provides low pass filtering of emitted or received signals. The contribution to low pass filtering is achieved mainly by the secondary cutouts. The stopband frequency is mainly determined by the effective length of the secondary cutouts. The waveguide surrounding at least a part of the length of the electromagnetic cutout provides attenuation at low frequencies and effectively acts as a high-pass filter. Furthermore, the waveguide improves the filtering performance of the low-pass filtering section by preventing the radiation of the secondary cutouts. Without the waveguide, secondary cutouts would radiate to other directions than the primary radiation direction.

The antenna element may comprise at least one planar dielectric substrate, wherein said at least one planar conductive layer is arranged on the planar dielectric substrate. The planar dielectric substrate provides support for the planar conductive layer. The planar dielectric substrate also provides possible support for a feeding device for feeding electromagnetic energy to the antenna element.

The antenna element may comprise dielectric material in the secondary cutouts. By providing dielectric material in the secondary cutouts the effective lengths of the cutouts is increased. Thus, if the desired stop band frequency requires long secondary cutouts, the actual necessary length may be decreased by adding the dielectric material in the secondary cutouts. Dielectric material may also be in the cutout between the main curves.

It might be preferable to tune the dielectric material in the secondary cutouts or in the space between the main curves to achieve the desired properties of the antenna element with regard to filtering frequencies, losses and impedance matching. One way of doing this is to provide the dielectric material with perforations. The mean dielectric constant of the dielectric material is decreased by such perforations.

The dielectric constant of the dielectric material may vary along the length axis. This enables the tuning of the antenna element such that the desired properties are achieved.

The two opposing parts of the first planar conductive layer may be electrically connected at a connection region, wherein the second end is configured between the connection region and the first end along the length axis. This technique is known per se from Vivaldi antennas and facilitates the implementation of feeding of electromagnetic energy to the antenna element. The opposing parts of the first planar conductive layer may then be transmission line converted by a so called balun.

The secondary cutouts may be essentially orthogonal to the main curves. This is one alternative for the direction of the secondary cutouts. Another alternative is to have the secondary cutouts essentially parallel to each other and orthogonal to the length axis.

The secondary cutouts may have a meandered shape. This allows the secondary cutouts to be longer within a certain limit for the overall extension of the secondary cutouts from the main curves to the end of the secondary cutouts.

The main curves of each opposing part may have the shape of an exponential curve. Such a configuration of the main curves provide favourable transmission and/or receiving properties of the antenna elements.

The main curves may be essentially symmetrical. Additionally, the opposing sides in the first planar conductive layer may be essentially symmetrical. This provides for predictable properties of the antenna element with regard to transmitting, receiving, or filtering properties of the antenna element.

The antenna element may comprise a second planar conductive layer, a third planar conductive layer on opposite sides of the first planar conductive layer, separated from the first planar conductive layer by planar dielectric substrates, and electrically connected to each other and to the first planar conductive layer along a part of the cutout to form the waveguide. In this way the waveguide is integrated in the same planar substrate as the rest of the antenna element.

The antenna element may comprise a fourth conductive layer between the first planar conductive layer and the second planar conductive layer or the third planar conductive layer, and a stripline feed or a microstripline feed, which is configured in the fourth planar conductive layer and is configured to feed the opposing sides in the first planar conductive layer with electromagnetic energy at the second end along the length axis. With such an antenna element also the feeding device for feeding electromagnetic energy is integrated in the same substrate.

The number of secondary cutouts in each opposing side in the first planar conductive layer may be in the range 5-20. Such a number makes it possible to tune the antenna element to minimize the losses and to provide the desired filtering.

According to a second aspect an antenna array is provided comprising a plurality of antenna elements according to the above aspect and having the above described possible additional features.

The antenna array may comprise a first set of antenna elements configured to transmit and/or receive, a signal having a first direction of polarization, and a second set of elements configured to transmit and/or receive, a signal having a second direction of polarization, which is different from the first direction of polarization.

### BRIEF DESCRIPTION OF THE DRAWINGS

FIG. 1 shows in a perspective view an antenna element 1 according to an embodiment.

FIG. 2 shows in a perspective view an antenna element 1 according to an alternative embodiment.

FIG. 3 is a plan view of an antenna element 1 according to an alternative embodiment.

FIG. 4 is a plan view of an antenna element 1 according to an alternative embodiment.

FIG. 5 is a plan view of an antenna element 1 according to an alternative embodiment.

FIG. 6 is a cross sectional view along A-A in FIG. 3.

FIG. 7 shows in a perspective view an antenna element according to an alternative embodiment.

FIG. 8 is a cross sectional view of the antenna element in FIG. 7.

FIG. 9 shows in a perspective view an antenna array comprising a plurality of antenna elements.

FIG. 10 is a plan view of the antenna array in FIG. 9.

### DETAILED DESCRIPTION

In the following description of embodiments reference will be made to the appended drawings. The same reference numeral will be used for similar features in the different drawings. The drawings are not to scale.

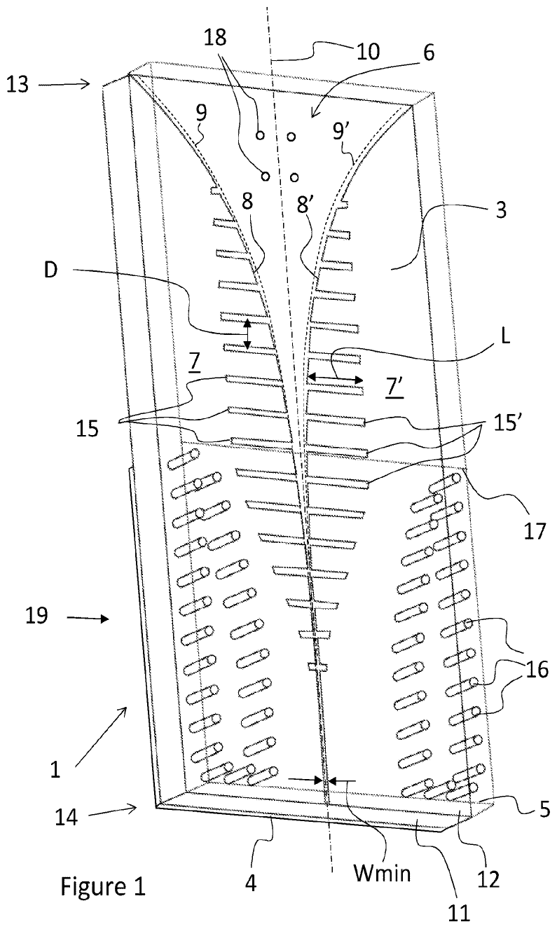

FIG. 1 shows an antenna element 1 according to an embodiment. The antenna element 1 comprises a first planar conductive layer 3, a second planar conductive layer 4 and a third planar conductive layer 5. In FIG. 1 the first planar conductive layer 3 is arranged between a first dielectric layer 11 and a second dielectric layer 12 which is transparent in FIG. 1. The second planar conductive layer 4 is configured on the opposite side of the first dielectric layer 11, in comparison with the first conductive layer 3. The third planar conductive layer 5 is configured on the opposite side of the second dielectric layer 12, in comparison with the first conductive layer 3. The first planar conductive layer 3, the second planar conductive layer 4, the third planar conductive layer 5, the first dielectric layer 11 and the second dielectric layer 12 together form the antenna element 1. The length axis 10 extends from a first end 13 of the first conductive layer 3 to a second end 14 of the first conductive layer 3. A cutout 6 is formed in the first planar conductive layer 3, which cutout 6 defines two opposing parts 7, 7′, of the conductive layer 3, wherein the opposing sides 8, 8′, of the opposing parts 7, 7′, follow a respective main curve 9, 9′, on respective sides of a straight length axis 10 in the plane of the conductive layer 3. The opposing parts 7, 7′, formed by the cutout 6, is the transmitting receiving part of the antenna element.

As can be seen in FIG. 1 the cutout extends from the first end 13 at one edge of the first conductive layer 3 to a second end 14 at the opposite edge of the first conductive layer 3. Thus, the two opposing parts 7, 7′, of the conductive layer 3 are not in direct contact with each other, but are connected to each other by means of the surrounding waveguide. The main curves 9, 9′, define a tapering shape from the first end 13 to the second end 14. The shape of the main curves 9, 9′, may be an exponential curve. As can be seen in FIG. 1 the cutout 6 comprises, in each one of the opposing sides 8, 8′, a plurality of secondary cutouts 15, 15′, extending from the main curves 9, 9′. The antenna element 1 also comprises a waveguide which surrounds a part of the length of the electromagnetic first planar conductive layer 3 along the length axis 10. As can be seen in FIG. 1 there are a plurality of electrical connections in the form of so called via fences 16 which extend from the second planar conductive layer 4, to the third planar conductive layer 5. The connection to the third planar conductive layer is not shown in FIG. 1. The via fences 16 are electrically connected to the first planar conductive layer 3, the second planar conductive layer 4, and to the third planar conductive layer 5. As can be seen in FIG. 1 the second planar conductive layer 4, and the third planar conductive layer 5, extend from the edge of the first planar conductive layer to the intermediate line 17. The second planar conductive layer 4, the third planar conductive layer 5, and the plurality of via fences 16 constitutes a waveguide 19. The length of the secondary cutouts 15, 15′, from the respective main curve 9, 9′, varies in the direction of the length axis 10, with the shortest secondary cutouts 15, 15′, closest to the ends of the cutout 6 along the length axis 10. Fabrication of the antenna element 1 may be done by providing the first dielectric layer 11 with the first planar conductive layer 3 on one side of the first dielectric layer and the second planar conductive layer 4 on top of it. The cutout 6 is formed, e.g., by etching of the first planar conductive layer by any conventional technique known to person skilled in the art. The forming of the second planar conductive layer 4 to the correct size and shape may be performed in a similar way or in the same way. The second dielectric layer 12 with the third planar conductive layer 5 may then be attached to the first planar conductive layer 3 with the third planar conductive layer 5 facing away from the first planar conductive layer 3, using a multi-layer PCB fabrication process known, per se, from the prior art. Due to the fabrication process, dielectric material will fill the cutout in the first planar conductive layer 3. Thus, the antenna element 1 comprises dielectric material in the secondary cutouts 15, 15′, as well as in the cutout as a whole.

In order to operate the antenna element 1 the opposing parts 7, 7′, in the first planar conductive layer 3 are fed with electromagnetic energy at the second end 14. Such feeding may be configured in many different ways, known per se to skilled persons. The tapering shape of the main curves 9, 9′, corresponds to the shape of a Vivaldi antenna element. In operation, the secondary cutouts 15, 15′, will function as a low-pass filter while the waveguide will function as a high-pass filter. The antenna element has a steep transition band and good attenuation at stopband.

Also shown in FIG. 1 the dielectric material has perforations 18 which are distributed along the length axis 10. The perforations may be in the form of holes extending through the dielectric material essentially perpendicular to the plane of FIG. 1. The perforations may be implemented to tune the effective dielectric constant of the dielectric material in the cutout. By varying the number and/or the size of the holes along the length axis the effective dielectric constant may be made to vary along the length axis 10.

The dielectric constant of the dielectric material may be made to vary along the length axis, in other ways than by the addition of perforations/holes 18. It is for example possible to vary the chemical composition of the dielectric material along the length axis 10.

In the embodiment in FIG. 1 the secondary cutouts 15, 15′, are essentially parallel to each other and are orthogonal to the length axis 10. The main curves of each opposing part have the shape of an exponential curve. Additionally, the main curves 9, 9′, and the opposing sides 8, 8′, of the opposing parts 7, 7′, are essentially symmetrical.

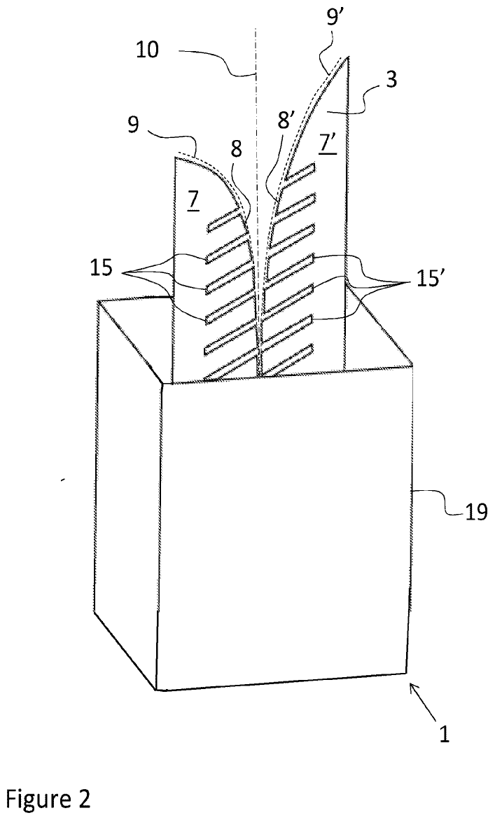

FIG. 2 shows an antenna element 1 according to an alternative embodiment. The antenna element comprises a first planar conductive layer 3. In contrast to the embodiment of FIG. 1, the first planar conductive layer 3 is not supported by any dielectric layer. The first planar conductive layer 3 may be a metal sheet, such as, e.g., a copper sheet or any other suitable metal. A cutout 6 is formed in the first planar conductive layer 3, which cutout 6 defines two opposing parts 7, 7′, of the conductive layer 3. The opposing sides 8, 8′, of the opposing parts 7, 7′, follow a respective main curve 9, 9′, on respective sides of a straight length axis 10 in the plane of the first planar conductive layer 3. The antenna element 1 also comprises a waveguide 19, which surrounds a part of the length of the cutout 6 along the length axis 10. In FIG. 2, the waveguide 19 is in the form of a square tube surrounding the lower part of the first planar conductive layer 3. The waveguide 19 may be shaped differently. The first planar conductive layer 3 may have the same shape as the first planar conductive layer 3 in FIG. 1. The part of the first planar conductive layer 3 below line 17 in FIG. 1 is hidden behind the waveguide 19 in FIG. 2.

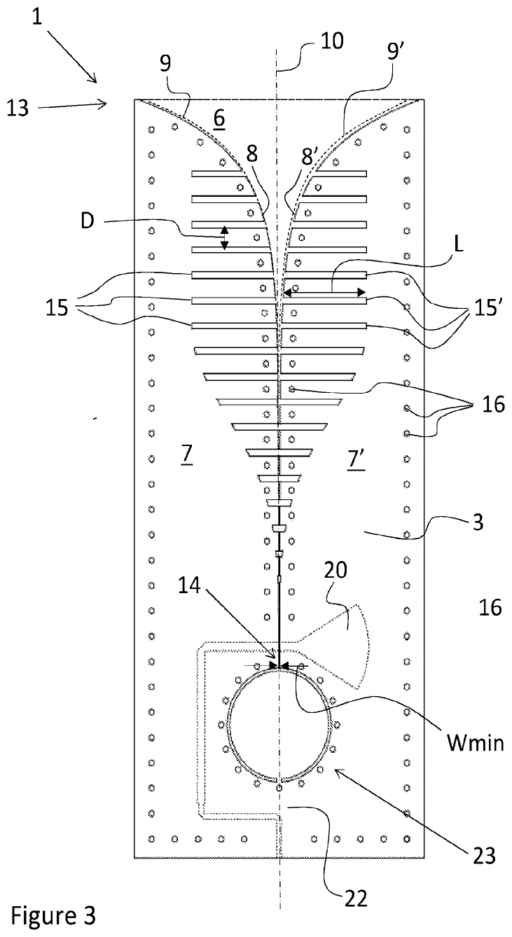

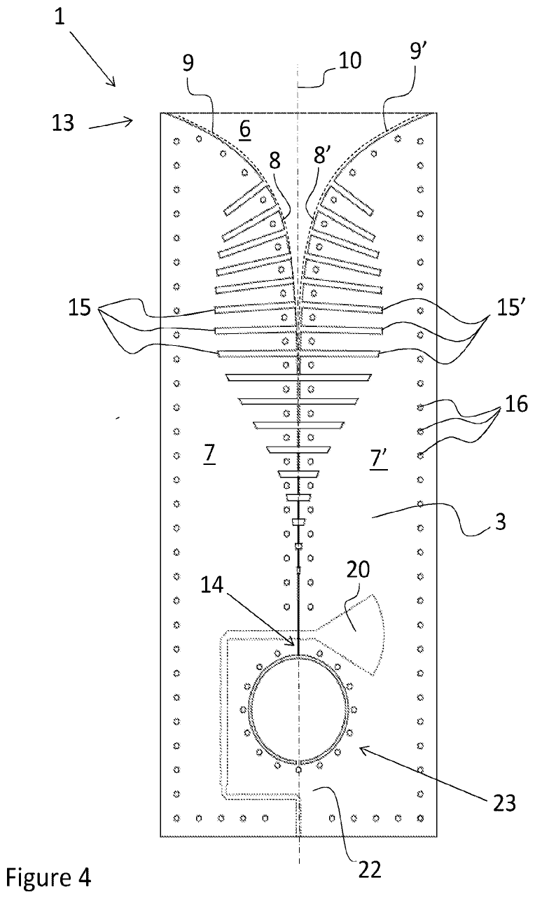

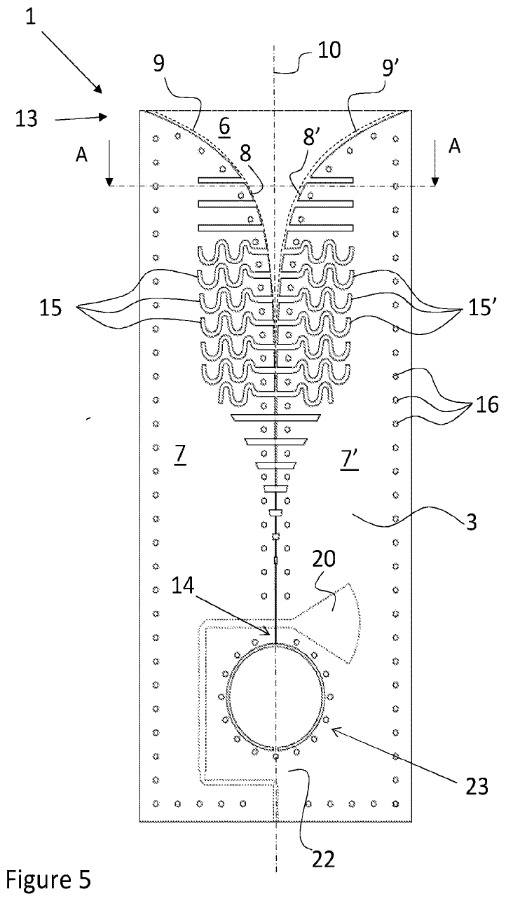

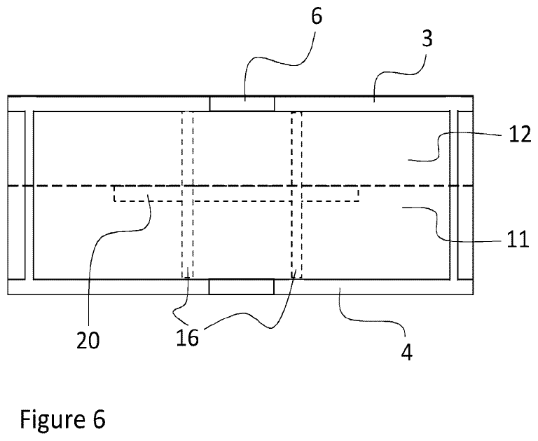

FIG. 3 is a plan view of an antenna element 1 according to an alternative embodiment. FIG. 4 is a plan view of an antenna element 1 according to an alternative embodiment. FIG. 5 is a plan view of an antenna element 1 according to an alternative embodiment. FIG. 6 is cross sectional view along A-A in FIG. 5. The antenna element 1 comprises a first planar conductive layer 3, a second planar conductive layer 4 (FIG. 6), and a third planar conductive layer 20 (FIG. 6). The second planar conductive layer 4 is not shown in FIGS. 3-5, but has a cutout with essentially the same shape as the cutout 6 in the first planar conductive layer 3.

Each one of the antenna elements 1 in FIGS. 3-5 comprises a first dielectric layer 11, and a second dielectric layer 12. The third planar conductive layer 20 is arranged between the first dielectric layer 11 (FIG. 6) and the second dielectric layer 12 (FIG. 6). The second dielectric layer 12 is arranged between the first planar conductive layer 3 and the third planar conductive layer 20. The first dielectric layer 11 is arranged between the second planar conductive layer 4 and the third planar conductive layer 20. The first planar conductive layer 3, the second planar conductive layer 4, the third planar conductive layer 20, the first dielectric layer 11, and the second dielectric layer 12together form the antenna element 1.

As shown in FIGS. 3-5, the length axis 10 extends along the cutout 6 from a first end 13 to a second end 14. The cutout 6 in the first planar conductive layer 3 defines two opposing parts 7, 7′, of the first planar conductive layer 3, wherein the opposing sides 8, 8′, of the opposing parts 7, 7′, follow a respective main curve 9, 9′, on respective sides of a straight length axis 10 in the plane of the conductive layer 3. A cutout is formed also in the second planar conductive layer 4 and has the same shape as the cutout 6 in the first planar conductive layer 3.

As is shown in FIGS. 3-5, the two opposing parts 7, 7′, of the conductive layer in the first planar conductive layer 3 are electrically connected at a connection region 22, wherein the second end 14 of the cutout 6 is configured between the connection region 22 and the first end 13 of the cutout along the length axis 10. Between the second end 14 of the cutout 6 and the connection region 22, a transmission line converter device 23 is formed in the first planar conductive layer 3. As said above the second planar conductive layer 4 comprises a similar transmission line converter device (not shown). Transmission line converter devices as shown in FIGS. 3-5 are per se known form Vivaldi antennas according to the prior art and will not be described in detail here. A stripline feed is configured in the third planar conductive layer 20 and is configured to feed the opposing parts 7, 7′, of the first planar conductive layer 3 and the second planar conductive layer 4 with electromagnetic energy at the second end 14 of the cutout along the length axis. Stripline feeds are per se known from Vivaldi antennas according to the prior art and will not be described in detail here. The function of the second planar conductive layer 4 is to avoid that the stripline feed radiates in the direction away from the first planar conductive layer 3. Instead the second planar conductive layer 4 doubles the first planar conductive layer 3.

Similarly to the embodiment of FIG. 1, the antenna element 1 of FIGS. 3-5 comprises via fences 16, which electrically connects the first planar conductive layer 3 with the second planar conductive layer 4.

In FIG. 4 the secondary cutouts 15, 15′, are perpendicular to the respective main curve 9, 9′, of the opposing sides 8, 8′. This is an alternative to the embodiment shown in FIG. 3.

In FIG. 5 the secondary cutouts 15, 15′, have a meander shape. This enables the length of the secondary cutouts 15, 15′, to be longer for a given total extension perpendicular to the length axis 10.

In FIG. 3 the length L of a secondary cutout 15′ and the period D of the secondary cutouts are shown. The period D is essentially the same along the length axis 10. It is, however, possible to have a varying period along the length axis 10. The length L of the secondary cutouts 15, 15′ varies along the length axis 10. The longest secondary cutouts 15, 15′, are in the middle region between the first end 13 and the second end 14.

In the embodiment of FIG. 3 the number of secondary cutouts is 17. Preferably, the number of secondary cutouts 15, 15′, in each opposing side 8, 8′, is 5-20. It is possible to have a larger number of secondary cutouts 15, 15′.

The period D of the cutouts is much less than a wavelength at the highest desired operational frequency. In practical filters, the period is less than half wavelength, preferably 0.05-0.25 wavelengths at the highest operational frequency. By the highest operational frequency is meant the highest frequency of the overall band, including the pass-band and stop-band regions. That is, if the pass band is at 6-18 GHz and the stop-band is at 18.5-40 GHz, the highest operational frequency is 40 GHz. The cut-off frequency, in turn, is about 18 GHz.

The longest cutouts essentially defines the filtering properties of the antenna element. The depth of the cutout is 0.15-0.35 wavelengths, preferably 0.20-0.30 wavelengths. The wavelength is defined at the desired cut-off frequency of the filter.

In practice, the above limitations results in that the length L of the longest secondary cutout 15, 15′, preferably is longer than the period D of the secondary cutouts 15, 15′.

In FIGS. 1 and 3 the smallest distance Wmin between the opposing parts 7, 7′ is at the second end 14. The length L of the longest secondary cutout 15, 15′, is longer than the smallest distance Wmin.

The antenna elements according to the embodiments shown in FIGS. 3-6 should be combined with the waveguide similarly as shown in FIG. 2.

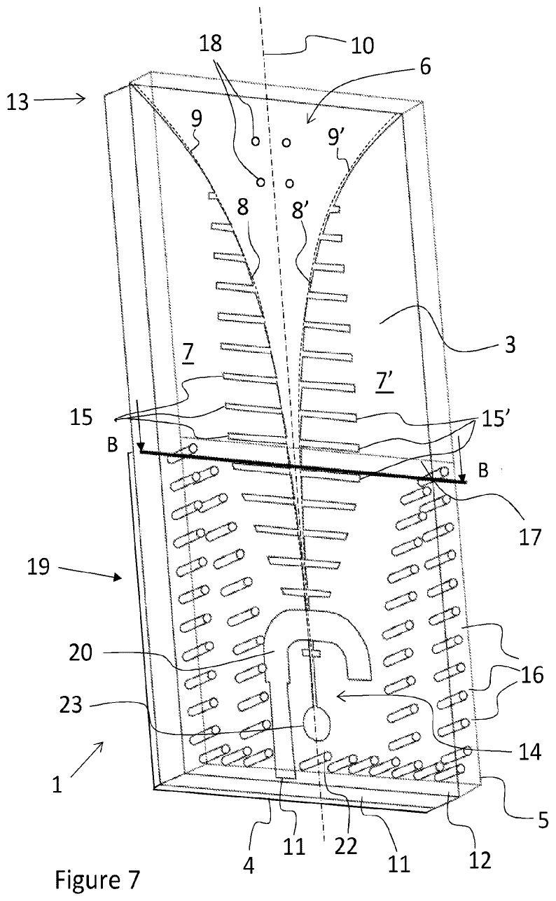

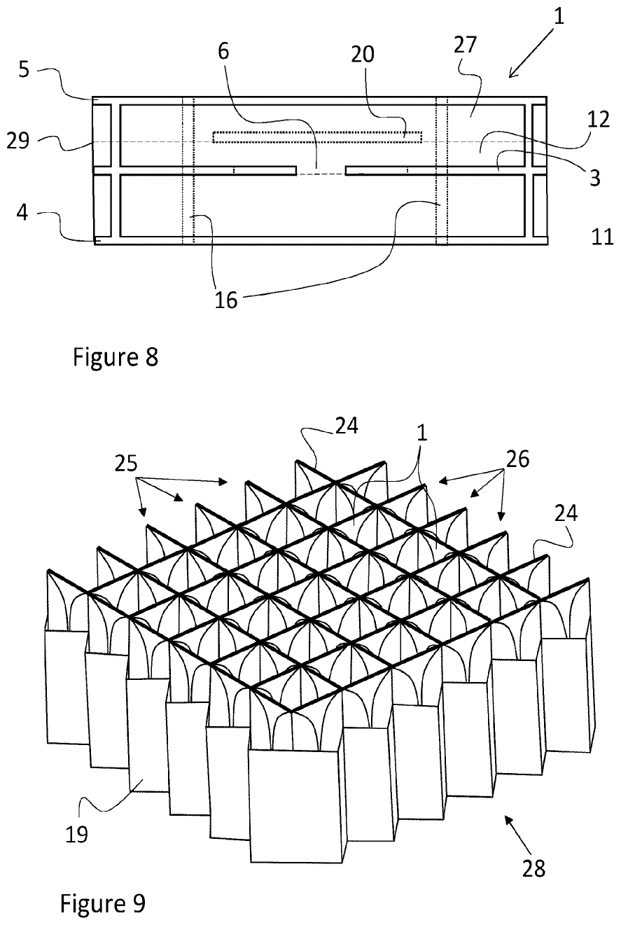

FIG. 7 shows in a perspective view an antenna element 1 according to an alternative embodiment. The antenna element 1 shown in FIG. 7 is similar to the antenna element 1 shown in FIG. 1. FIG. 8 is a cross sectional view of the antenna element along B-B in FIG. 7. The antenna element comprises a first planar conductive layer 3, a second planar conductive layer 4 and a third planar conductive layer 5. In FIG. 1 the first planar conductive layer 3 is arranged between a first dielectric layer 11 and a second dielectric layer 12 which is transparent in FIG. 1. The second planar conductive layer 4 is configured on the opposite side of the first dielectric layer 11, in comparison with the first conductive layer 3. The two opposing parts 7, 7′, of the conductive layer in the first planar conductive layer 3 are electrically connected at a connection region 22, wherein the second end 14 of the cutout 6 is configured between the connection region 22 and the first end 13 of the cutout along the length axis 10. Between the second end 14 of the cutout 6 and the connection region 22, a transmission line converter device 23 is formed in the first planar conductive layer 3. The transmission line converter device 23 is slightly different from the transmission line converter devices 23 shown in FIGS. 3-5. Transmission line converter devices 23 as shown in FIG. 7 are per se known form Vivaldi antennas according to the prior art and will not be described in detail here. A stripline feed 20 is configured in a fourth planar conductive layer 29 and is configured to feed the opposing parts 7, 7′, of the first planar conductive layer 3 with electromagnetic energy at the second end 14 of the cutout along the length axis. Stripline feeds are per se known from Vivaldi antennas according to the prior art and will not be described in detail here. The antenna element 1 comprises a third dielectric layer 27 arranged between the fourth planar conductive layer 20 and the third planar conductive layer 5. The layers are clearly shown in FIG. 8.

FIG. 9 shows in a perspective view an antenna array 28 comprising a plurality of antenna elements 1, which are arranged on a plurality of planar dielectric substrates 24. The planar dielectric substrates 24 are arranged crossing each other such that the antenna array 28 comprises a first set 25 of antenna elements 1 configured to transmit and/or receive, a signal having a first direction of polarization, and a second set 26 of antenna elements 1 configured to transmit and/or receive, a signal having a second direction of polarization, which is different from the first direction of polarization. A waveguide 19 is arranged around the each antenna element 1. The individual electromagnetic radiators may be as in any of the embodiments described above.

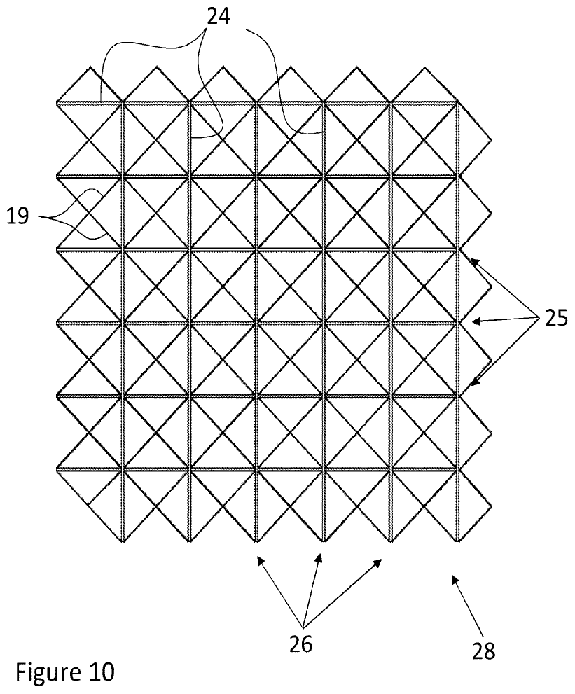

FIG. 10 is a plan view of the antenna array 28 in FIG. 9. In FIG. 10 it can be more clearly seen that a waveguide 19 is arranged around each antenna element 1.

The above described embodiments may be amended in many ways without departing from the scope of the present invention, which is limited only by the appended claims.

1-15. (canceled)

16. An antenna element (1) comprising:
at least a first planar conductive layer (3), wherein a cutout (6) is formed in the first planar conductive layer (3), which cutout (6) defines two opposing parts (7, 7′) of the conductive layer (3), wherein the opposing edges (8, 8′) of the opposing parts (7, 7′) follow a respective main curve (9, 9′) on respective sides of a straight length axis (10) in the plane of the conductive layer (3), wherein the main curves (9, 9′) define a tapering shape from a first end (13), at an edge of the first planar conductive layer (3), to a second end (14), and wherein the cutout (6) comprises, in each one of the opposing sides (8, 8′) a plurality of secondary cutouts (15, 15′) extending from the main curves; and
a waveguide (19) surrounding at least a part of the length of the cutout (6) along the length axis (10), and in that the lengths (L) of the secondary cutouts (15, 15′) from the main curves (9, 9′) vary in the direction of the length axis (10), with the shortest secondary cutouts (15, 15′) closest to the ends of the cutout (6) along the length axis (10).

17. The antenna element (1) according to claim 16, further comprising at least one planar dielectric layer (11), wherein said at least one planar conductive layer (3) is arranged on the planar dielectric layer (11).

18. The antenna element (1) according to claim 17, further comprising dielectric material in the secondary cutouts (15, 15′).

19. The antenna element (1) according to claim 16, further comprising dielectric material in the secondary cutouts (15, 15′).

20. The antenna element (1) according to claim 19, wherein the dielectric material has perforations (18).

21. The antenna element (1) according to claim 20, wherein the dielectric constant of the dielectric material varies along the length axis (10).

22. The antenna element (1) according to claim 19, wherein the dielectric constant of the dielectric material varies along the length axis (10).

23. The antenna element (1) according to claim 16, wherein the two opposing parts of the first planar conductive layer (3) are electrically connected at a connection region (22), wherein the second (14) end is configured between the connection region (22) and the first end (13) along the length axis (10).

24. The antenna element (1) according to claim 16, wherein the secondary cutouts (15, 15′) are essentially orthogonal to the main curves (9, 9′).

25. The antenna element (1) according to claim 16, wherein the secondary cutouts (15, 15′) are essentially parallel to each other and orthogonal to the length axis (10).

26. The antenna element (1) according to claim 16, wherein the secondary cutouts (15, 15′) have meandered shape.

27. The antenna element (1) according to claim 16, wherein the opposing sides (8, 8′) in the first planar conductive layer (3) are essentially symmetrical.

28. The antenna element (1) according to claim 16, further comprising a second planar conductive layer (4), a third planar conductive layer (5) on opposite sides of the first planar conductive layer (3), separated from the first planar conductive layer (3) by planar dielectric substrates (11, 12), and electrically connected to each other and to the first planar conductive layer (3) along a part of the cutout to form the waveguide (19).

29. The antenna element (1) according to claim 28, further comprising a fourth conductive layer (20) between the first planar conductive layer (3) and the second planar conductive layer (4) or the third planar conductive layer (5), and a stripline feed or a microstripline feed (20), which is configured in the fourth planar conductive layer (29) and is configured to feed the opposing sides (8, 8′) in the first planar conductive layer (3) with electromagnetic energy at the second end (14) along the length axis (10).

30. The antenna element (1) according to claim 16, wherein the number of secondary cutouts (15, 15′) in each opposing side (8, 8′) in the first planar conductive layer (3), preferably is in the range 5-20.

31. An antenna array (28) comprising a plurality of the antenna elements (1) according to claim 16.

32. The antenna array (28) according to claim 31, further comprising a first set (25) of antenna elements (1) configured to transmit and/or receive, a signal having a first direction of polarization, and a second set (26) of elements (1) configured to transmit and/or receive, a signal having a second direction of polarization, which is different from the first direction of polarization.
